(19) United States
(12) Patent Application Publication
(10) Pub. No.: US 2016/0176636 A1
(43) Pub. Date: Jun. 23, 2016

(54) Picking Display Device and Picking Display System

(71) Applicant: HITACHI, LTD., Tokyo (JP)

(72) Inventors: Yoriko KAZAMA, Tokyo (JP); Junichi KIMURA, Tokyo (JP)

(21) Appl. No.: 14/909,548

(22) PCT Filed: Aug. 7, 2013
(86) PCT No.: PCT/JP2013/071317

§ 371 Date: Feb. 2, 2016

(51) Int. Cl. B65G 1/137; B65G 1/10

(52) U.S. Cl. CPC B65G 1/1371; B65G 1/10

(57) ABSTRACT

When an item as an object is picked from a conveyor conveying a shelf in which items are stored, efficient picking providing fewer errors is achieved. In a picking display device according to the present invention, a controller displays information on an object conveyor in advance, and displays a position of an item to be picked in conjunction with movement of the conveyor.

### TECHNICAL FIELD

The present invention relates to a device for displaying the most appropriate instruction for picking so that a conveyor and a picking instruction display device are linked.

For picking a predetermined item from a warehouse in which a number of items are stored, a technique is known in which positions of the items in the warehouse are registered into a database and the position of the object item is searched and displayed, so that a picking instruction is given. Further, there is a technique for picking a number of items efficiently, in which the order of accesses to the items in a path is calculated and picking instructions are given sequentially. Furthermore, there is a technique in which, instead that a worker moves in the warehouse to perform picking, the item as the object or a shelf storing the item as the object therein is conveyed by an automatic conveyor to a place of a worker, so that picking is performed.

In a case where the picking instruction is given to the worker, there is a technique in which a shutter at a position at which the item as the picking object is stored is automatically opened and closed. Further, there is a technique of irradiating the position at which the object item is stored with a pointer. In addition, a technique is known in which a lamp of the shelf storing the predetermined item therein lights up towards the worker or when the worker comes closer to that shelf.

### CITATION LIST

### Patent Literature

Patent Literature 1: Japanese Unexamined Patent Application Publication No. Hei8(1996)-91514

### Patent Literature 2: Japanese Patent No. 5149775

### Patent Literature 3: Japanese Patent No. 4119861

### Patent Literature 4: Japanese Unexamined Patent Application Publication (Translation of PCI Application) No. 2007-536706

### Patent Literature 5: United States Patent No. 2003/0156427

### SUMMARY OF INVENTION

### Technical Problem

In a case where the automatic conveyor delivers items to the place of the worker one after another, the worker has to check the stored position and the name of each item that are displayed after the automatic conveyor is stopped and to take out the item as the object. Therefore, it takes time to understand the storage position, thus reducing picking efficiency. Further, there is a possibility that picking errors increase.

### Solution to Problem

The present invention has been made for solving the above-described problems. It is an object of the present invention to provide a display device that efficiently gives a picking instruction without an error by lighting up a frontage position of an item stored in a shelf by means of an indicator before a conveyor stops and changing the position of the indicator lighting up in conjunction with movement of the conveyor.

### Advantageous Effects of Invention

According to the packing display device of the present invention, a stored position of an item is found before a conveyor is stopped, and a position can be visually recognized easily because the display moves, and the position of the item can be found in advance. Those enable efficient picking.

### BRIEF DESCRIPTION OF DRAWINGS

FIG. 1 is a conceptual diagram of a picking display device 100 according to a first embodiment;

FIG. 2 is a configuration diagram of the picking display device 100 according to the first embodiment;

FIG. 3 is a detailed configuration diagram of the picking display device 100 according to the first embodiment;

FIG. 4 is a diagram illustrating an example of data included in a data accumulation unit 300;

FIG. 5 is a conceptual diagram illustrating an expected arrival position of a conveyor in a position notifying unit 306;

FIG. 6 is a sequence diagram of the picking display device 100 according to the first embodiment;

FIG. 7 is a configuration diagram of a picking display device 100 according to a second embodiment;

FIG. 8 is a conceptual diagram of a picking display device 100 according to a third embodiment;

FIG. 9 is a conceptual diagram of a picking display device 100 according to a fourth embodiment;

FIG. 10 is a conceptual diagram of a picking display device 100 according to a fifth embodiment;

FIG. 11 is a conceptual diagram of a picking display device 100 according to a sixth embodiment;

FIG. 12 is a diagram illustrating a picking display device 100 of an eighth embodiment; and

FIG. 12 is a diagram illustrating a picking display device 100 of a ninth embodiment.

### DESCRIPTION OF EMBODIMENTS

### First Embodiment

Before embodiments are described, terms are defined as follows.

A position of a conveyor shows a position of the conveyor with respect to a floor surface and is given by (X, Y) coordinates. In this case, it indicates a position on a predetermined map. An item frontage position shows a frontage of an item stored in a shelf and is given by a column and a row of the shelf, for example. A display position shows a position of a display device provided on a gate including the display device, and indicates a horizontal position and a vertical position. A picking station is assumed to be stationary on the map. However, it does not need to be fixed. The conveyor is assumed to hold the shelf, and the position of the conveyor and that of the shelf on the map are identical.

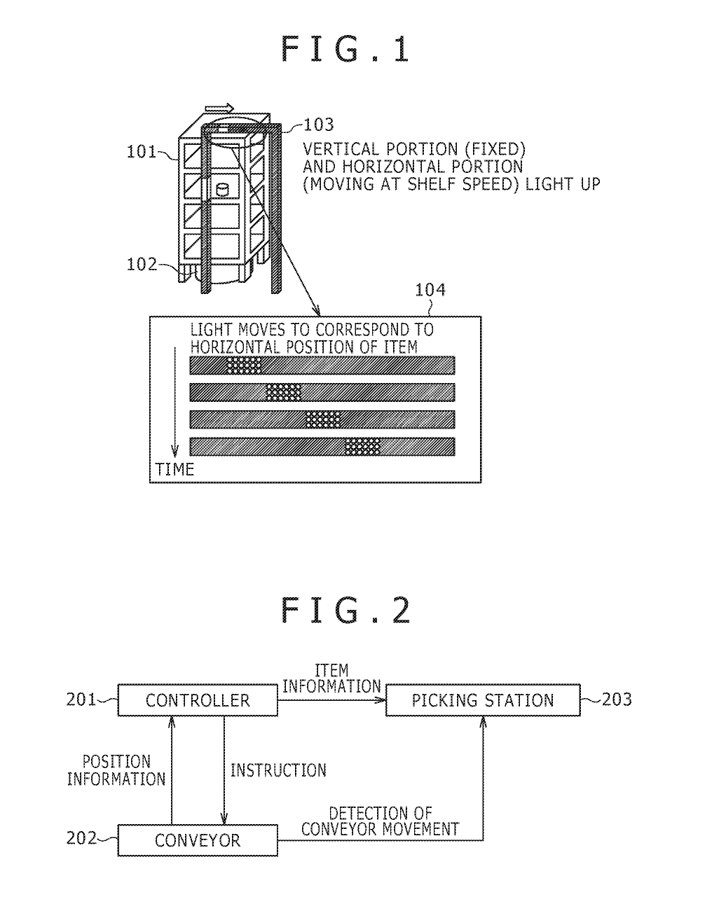

FIG. 1 is a diagram illustrating a picking display device that is a first embodiment of the present invention. When a conveyor 102 transporting a shelf 101 in which an item is stored comes close to a gate 103 provided with display devices, a display device lights up. A lighting position of the display device, indicating a stored position of the item, is changed to correspond to movement of the conveyor 102. The gate 103 has the display device, and a lamp such as an LED lights up by an instruction. Instead of the LED, a lamp, a liquid crystal panel or the like may be used. The gate 103 is designed to have the same size as the shelf and the conveyor, and forms an outer frame of the shelf. The gate may be the same in size as the outer frame or be larger than it. Further, in addition to the outer frame, a lateral frame may be provided in the gate to fit a lateral plate of the shelf. Although an example is shown in which the gate 103 is arranged at a position away from a conveyance path of the conveyor 102, a configuration can be employed in which the display device is arranged at a position where it does not obstruct a conveyance work of the conveyor 102. A change in display in the display device with the gate 103 is illustrated in an enlarged view 104. A display position corresponding to a vertical position with respect to the frontage of the shelf in which an item is stored lights up, and a display device corresponding to a horizontal position lights up in conjunction with movement of the conveyor. When the conveyor comes closer to the gate 103, a display device at a position to which the conveyor 102 comes closer lights up. When the conveyor 102 moves, a display device at a horizontal position of an item corresponding to the gate is stored lights up. When the conveyor 102 arrives at a predetermined position, the lighting is changed to a lighting indication indicating the arrival. For example, lighting flashes during the movement of the conveyor 102, and lighting is continuous when the conveyor 102 has stopped. Further, a buzzer, sound, or an indication on a separately provided display may be used for notification of the arrival.

FIG. 2 illustrates a configuration in the first embodiment. A conveyor 202 receives an instruction from a controller 201 and conveys a predetermined shelf. The conveyor 201 move towards a picking station 203 as a target point. A conveyance path may be instructed by the controller 201, or the conveyor 202 may automatically travel towards the target point given from the controller. The conveyor 202 notifies the controller 201 of a position thereof on a map which changes with the movement thereof as position information at any time. The position information may be notified to the controller every time the conveyor moves, or when the conveyor has arrived at a predetermined position. The controller 201 finds the conveyor 201 which will arrive at the picking station 203 from the position information on the map notified from the conveyor 202, and reads out item information containing a shelf held by that conveyor 202, a frontage in which an item is stored, and the like. The controller 201 then notifies the picking station. 203 of the read item information. The picking station 203 detects the position of the conveyor 203, and makes a display device corresponding to a frontage position of an item held by the conveyor 203 that is going to arrive light up.

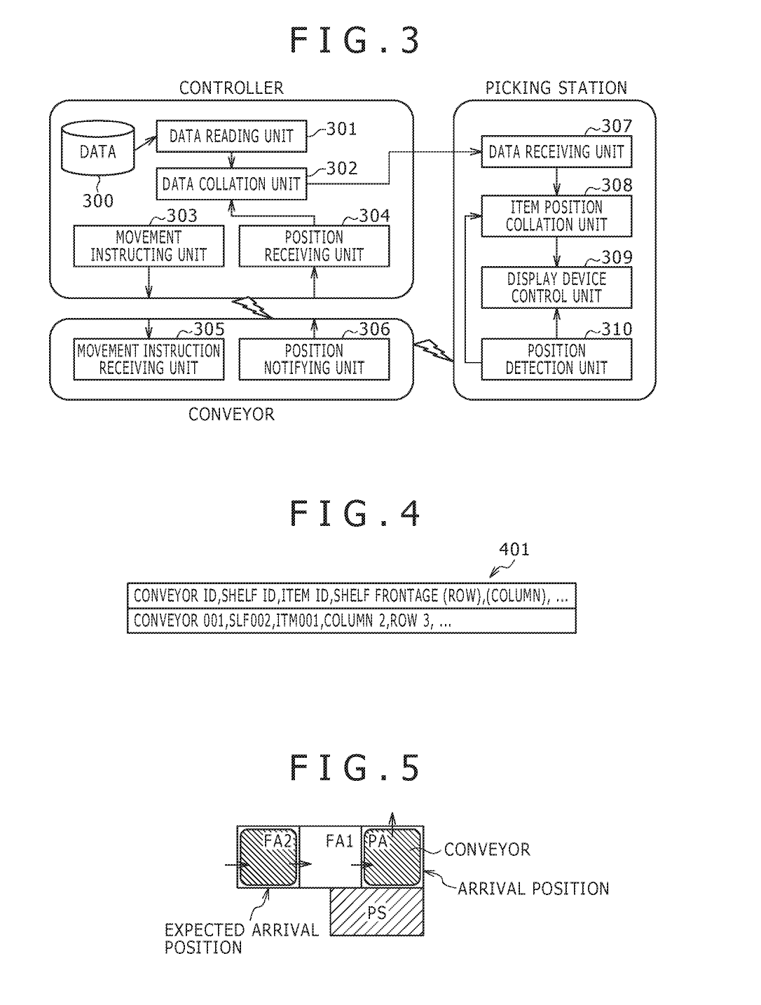

FIG. 3 is a diagram illustrating the details of FIG. 2 illustrating the configuration in the first embodiment. FIG. 4 illustrates an example of data, and FIG. 5 schematically illustrates movement of a conveyor. The configuration in the first embodiment is described with reference to FIGS. 3, 4, and 5.

The controller 201 has a data accumulation unit 300 holding information on items, shelves, and the conveyor, and stores a storage position of an item in a shelf and item information. The controller 201 also stores data of correspondence between a conveyor and a shelf conveyed thereby. The data has a data set in which one line represents one item, as shown in FIG. 4. For example, the data includes a conveyor ID, a shelf ID of a shelf conveyed by a conveyor, an item. ID stored in the shelf, column and row numbers of a shelf frontage in which the items is stored, and the like. Further, for a corresponding item, a required number of the item, the name of the item, and the like may be also stored. The data is configured to include a plurality of lines. The data accumulation unit 300 may be held in the controller or in an external database.

A data reading unit 301 reads out information on a predetermined item, a shelf, a storage frontage position of the item in the shelf, a required number of the items, and the like from the data accumulation unit 300.

A data collation unit 302 extracts, from information on the item and shelf read out from the data reading unit 301 and position information of a conveyor received by a position receiving unit 304, a corresponding conveyor and performs check. When a conveyor has arrived at an expected arrival position that is predetermined, as shown in FIG. 5, a next conveyor arriving at an arrival position is found. Thus, the next arriving conveyor is extracted as the corresponding conveyor.

A movement instructing unit 303 designs a conveyance path to a predetermined picking station as a destination for conveying a predetermined shelf to the picking station, and transmits the conveyance path as a movement instruction to the conveyor.

A position receiving unit 304 receives a position of a conveyor on a map which is notified from the conveyor. The position information indicating the notified conveyance path is a coordinate position on the map. The position receiving unit 304 may be a function provided in the picking station.

A movement instruction receiving unit 305 receives the movement instruction notified from the movement instructing unit 303 of the controller 201 and moves the conveyor in accordance with the received movement instruction.

The conveyor determines the position thereof on the map, a position notifying unit 306 notifies the controller of a current position of the conveyor. The position is represented by a coordinate on the map. The conveyor can determine the position thereof on the map with a marker provided on a floor surface or by checking surrounding circumstances with a camera mounted on the conveyor. Further, the conveyor may determine the position thereof by a wireless network. Furthermore, the conveyor may hold a moving track from a start, which is obtained by odometry, for example, and determine the position thereof from the moving track. In addition, for notification of arrival at the expected arrival position shown in FIG. 5, determination may be performed by matching the position of the conveyor obtained in the above-described manner and the expected arrival position, or the arrival may be notified to a system by a contact sensor or the like provided on the floor surface when the conveyor has arrived at the expected arrival position. Also, the position notifying unit 306 may notify the picking station of the position of the conveyor. When the conveyor has arrived at the arrival position shown in FIG. 5, the position notifying unit 306 issues an arrival notification, the position receiving unit 304 accepts the arrival notification, and the data collation unit 302 checks the corresponding conveyor and the information on the shelf and the item and notifies the picking station of arrival information.

A data receiving unit 307 receives the item storage position in the corresponding shelf and the item information checked by the data collation unit 302.

An item position collation unit 308 compares the storage position of the item in the shelf received in the data receiving unit 307 and a shelf position of a position detection unit 310 with each other, and sets the item storage position in the shelf held by the conveyor that is moving.

A display device control unit 309 links the item storage position checked by the item position collation unit 308 and a position on the map of the conveyor and the shelf of the position detection unit. 310, and makes a display device corresponding to the item storage position in the shelf that is moving light up. In linking, a horizontal relative distance with respect to the gate is calculated from a reference position on the map of the picking station and a reference position of the conveyor. The reference positions are a position of the center of gravity of the gate provided in the picking station and that of the center of gravity of the conveyor, for example. In a case where the conveyor approaches from the left side of the gate, the reference position of the picking station may be located at the right end of the gate while the reference position of the conveyor is located on the right end of the conveyor. A horizontal distance of the frontage position at which the item is stored from the reference position of the shelf is calculated and is added to the calculated relative distance, so that a display device corresponding to the obtained position is made to light up. Further, the lighting display is changed in accordance with the position on the map of the movement of the shelf notified from the position detection unit 310. The picking station receives a notification that the conveyor and the shelf has stopped from the controller, and changes a manner of the lighting of a corresponding display device to blinking or the like.

The position detection unit 310 detects the position of the conveyor with the movement of the conveyor. The detection is achieved by measurement with a laser range finder, so that a detailed position of the conveyor and shelf is detected. The detection may be achieved by image detection using a camera or the like, or detection using laser. Further, the detection of the position on the map may be achieved by using the position of the conveyor that is determined by the conveyor itself and is notified by communication through a wireless network or the like. The detection may be achieved by using the position of the conveyor obtained by reading a marker attached onto a floor surface and notified. In addition, while a barcode or the like may be provided for check of shelves, the provided barcode may be read with a barcode reader, so that the shelves are checked.

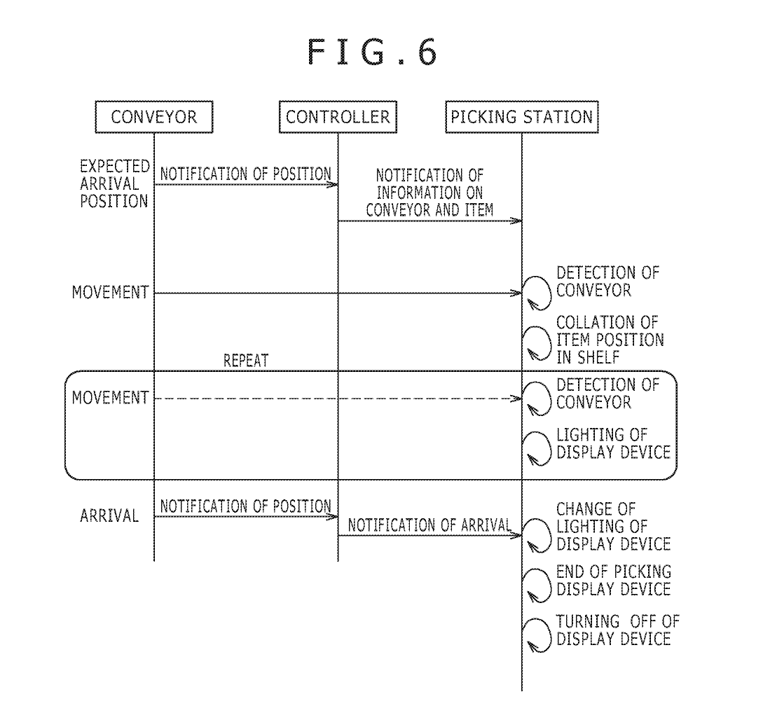

FIG. 6 is a diagram of a process sequence in the first embodiment.

When a conveyor has arrived at an expected arrival position specified in advance, the conveyor notifies the controller of the position on the map of the conveyor. The controller receiving the notification checks a corresponding conveyor. Further, the controller checks the conveyor and information on a shelf transported by the conveyor and a frontage position of an item stored in the shelf, for example, and notifies the picking station of the information on the conveyor, the item, and the like. The picking station checks the frontage position in the shelf at which the item is stored and the position on the map of the conveyor, and makes a corresponding display device light up. When the conveyor moves, the movement of the conveyor is detected and a change of the position with the movement of the conveyor is detected in the picking station, so that the display device that is made to light up is changed. There are repeated. When the conveyor has arrived at the arrival position, the conveyor determines the arrival thereof and notifies the controller of it, and the controller issues an arrival notification to the picking station. The picking station changes the lighting of the display device. Further, when picking of a predetermined item is terminated in the picking station, the picking station is notified of the termination of picking and turns off the display device. In this step, the termination of picking may be determined by automatic detection that the corresponding item picked from the shelf conveyed by the conveyor has been placed into a shipping box installed in the picking station by a weighing device or the like. Alternatively, a worker may issue a termination notification through a terminal or an event in which the worker presses a button or the like, when terminating picking. Alternatively, a system may determine the termination of picking from an image captured by a camera provided in the picking station.

### Second Embodiment

In the first embodiment, the conveyor determines its own position on the map and notifies the controller of it. In the second embodiment, a form is described in which, in a case where the conveyor travels and arrives at the picking station in a predetermined order, the conveyor does not notify the controller of its own position.

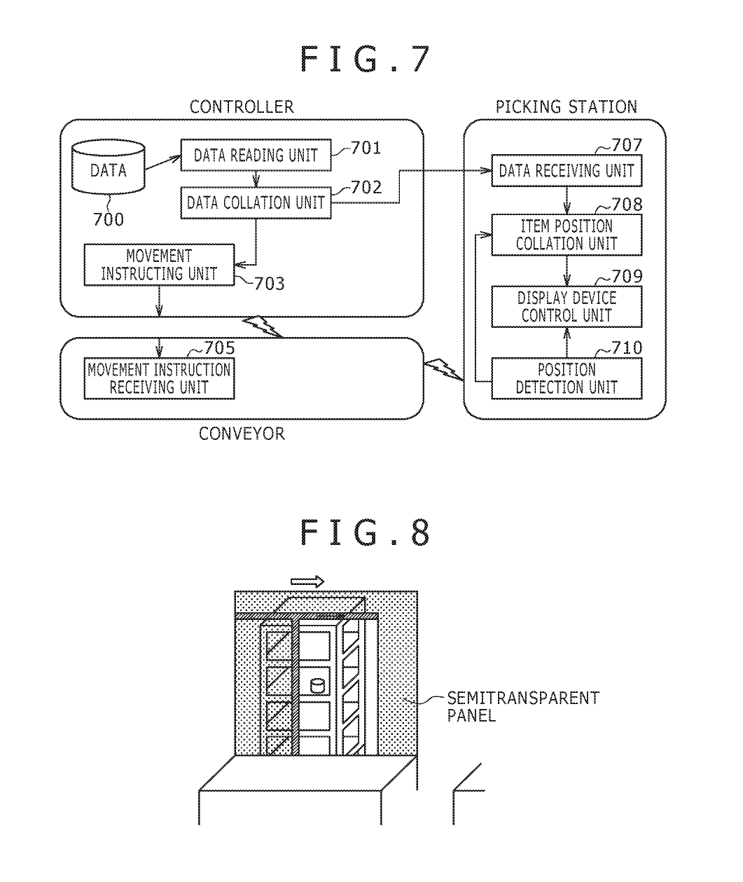

FIG. 7 is a function diagram in the second embodiment. A movement instruction unit 703 sets a moving path of each conveyor based on a predetermined order of arrival for a plurality of conveyors. The movement instruction unit 730 notifies the conveyors of the set conveyance path, and the conveyors receive the conveyance path by their respective movement instruction receiving units and move along the path. A data collation unit checks information on a shelf and an item in the order in which the conveyors arrive at the picking station, and notifies the picking station of the checked information. In a case of a single conveyor, it is not necessary to determine the order in advance, and it is enough to notify the picking station of a list of the information on conveyed shelves and items. The picking station may be notified in advance or every time a conveyor arrives at a predetermined expected arrival position. When a position detection unit in the picking station has detected a conveyor and a shelf, the picking station reads out information on a storage position of an item in an order notified from the controller, and makes a display device at an item frontage position in the shelf light up. The shelf being conveyed by the conveyor and the information on the shelf from the controller may be compared, so that the notification information is checked. A barcode provided in a shelf or the like may be read out with a barcode reader provided in the picking station, so that the check is performed.

In this manner, it is possible to achieve a picking display device without a notification of the conveyor's position from the conveyor.

### Third Embodiment

In the first and second embodiments, forms been described in which the gate-type picking display device is provided in the picking station. In the third embodiment, a semitransparent panel is installed in the gate provided with display devices.

FIG. 8 is a diagram illustrating a picking display device according to the third embodiment. A semitransparent panel is added to a gate, and display devices provided in the gate are arranged to extend in an approaching direction of a conveyor. Movement of the conveyor is detected in the picking station, and an indicator in the display device corresponding to an item frontage position in a corresponding shelf lights up in conjunction with the movement, as in the first embodiment.

In this manner, a distance and a time period in which a notification of an item position is issued in advance can be made longer. Further, the use of the semitransparent panel enables the movement of the conveyor to be seen. Furthermore, because the semitransparent panel is arranged to separate the conveyor and a worker from each other, an effect of an accident of a fall of a shelf caused by a movement error of the conveyor can be reduced, this providing a sense of security to the worker psychologically.

### Fourth Embodiment

In the third embodiment, the picking station is provided with the gate and the semitransparent panel. In the fourth embodiment, the picking station is provided with the semitransparent panel and a movable shutter, and is also provided with an indicator.

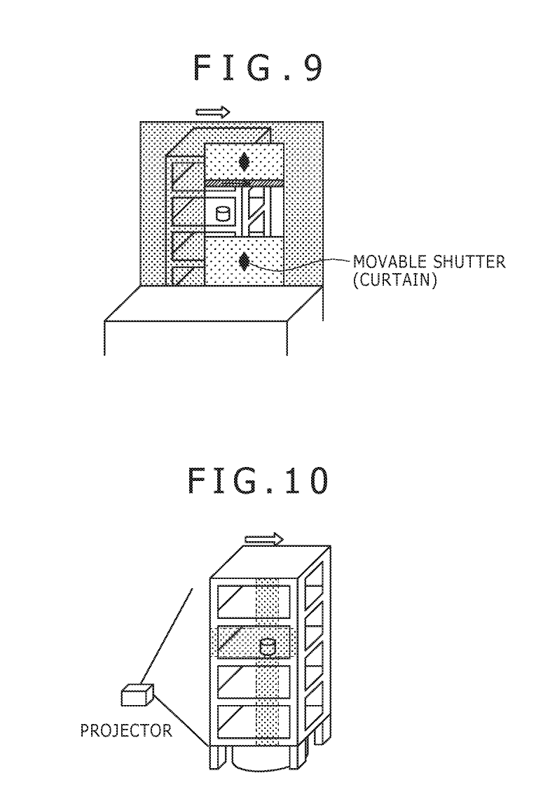

FIG. 9 is a diagram illustrating a picking display device according to the fourth embodiment. When a conveyor and a shelf approach the picking station, an indicator indicating a position of a corresponding item stored in the shelf lights up. When the conveyor stops at a stop position, the shutter is opened at a position at which the corresponding item is stored. When picking is terminated, that shutter is closed.

In this manner, it is possible to recognize the storage position of the item in advance and take the item from a corresponding frontage only. Therefore, picking errors can be reduced.

### Fifth Embodiment

In the first embodiment, while the gate provided with the display devices is installed in the picking station, picking display is achieved by making a corresponding di splay device light up when a conveyor and a shelf approach thereto. In the fifth embodiment, display of a picking instruction is performed by projection on the shelf by means of a projector or the like.

FIG. 10 is a diagram illustrating a picking display device according to the fifth embodiment. Projection of a frontage position of an item stored in a shelf is performed onto the shelf by means of a projector or the like. The projection is performed such that vertical and horizontal lines of the frontage position as an object are shown and the frontage of the item is located on the crossing of the lines. Further, the projection may be performed such that only a corresponding frontage lights up. As a conveyor moves, a movement detection unit of the picking station detects the movement of the conveyor, and the projector or the like is rotated in conjunction with the movement of the conveyor to change the projection. When seen from the shelf surface, the projected image on the shelf does not change even when the conveyor moves.

In this manner, it is possible to display a predetermined item frontage position without installing a gate or the like, and to confirm the position prior to arrival of the conveyor.

### Sixth Embodiment

In the fifth embodiment, the item frontage position is displayed by means of the projector or the like. In the sixth embodiment, a picking display device is described that also projects item information.

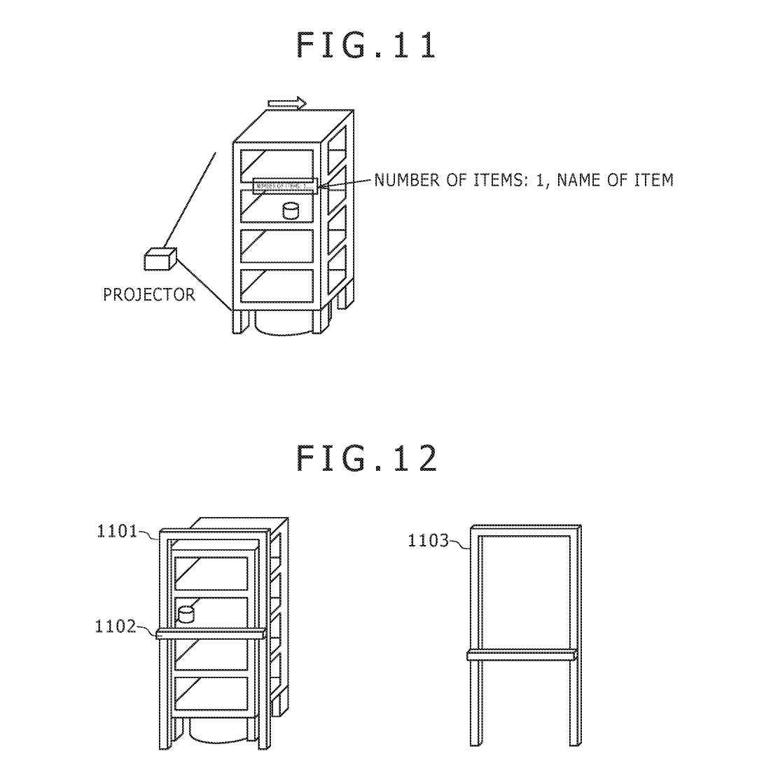

FIG. 11 is a diagram illustrating a picking display device according to the sixth embodiment. The number of items to be picked and the name of the item are projected near a frontage in which the item to be picked is stored. As a conveyor moves, a movement detection unit of the picking station detects the movement of the conveyor, and the projector or the like is rotated in conjunction with the movement of the conveyor to change the projection. When the shelf surface is regarded as a reference, the projected image does not change. Further, the information such as the name of the item and the number of items may be projected after the conveyor stops, not when the conveyor is moving.

In this manner, it is possible to display item information such as the name of an item to be picked and the number of picked items, near the frontage of the item to be picked, so that movement of a sight line of a picking worker can be reduced. Therefore, it is possible to reduce misrecognition of the display such as the number of the picked items, and picking errors. Also, it is possible to reduce ease of tiredness of the worker.

### Seventh Embodiment

In the first embodiment, when a conveyor conveying a shelf has arrived at a predetermined position with respect to the gate-type picking display device, a worker picks a corresponding item. In the seventh embodiment, when the conveyor has arrived at the predetermined position, the shelf conveyed by the conveyor is joined to the gate. This joining is achieved by providing an electromagnet in the gate. Further, a material such as rubber may be pasted onto the gate, so that the gate can be brought into close contact with the shelf. When picking is terminated, the joining of the gate and the conveyor is released in response to a picking termination notification. Thus, when the conveyor has stopped, a current is supplied to the electromagnet so that the shelf made of metal and the electromagnet provided in the gate are joined. This joining can be released by cutting the current in response to the picking termination.

In this manner, it is possible to prevent a worker's body from being caught between the shelf and the gate because of the movement of the conveyor by mistake during picking. Further, because the shelf is stabled, picking can be performed easily.

### Eighth Embodiment

In the eighth embodiment, a bar having display devices that can move up and down is further provided in the gate-type picking display device described in the first embodiment.

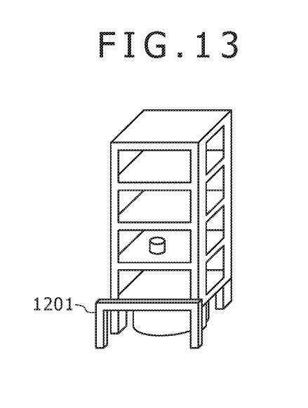

FIG. 12 is a diagram illustrating a picking display device according to the eighth embodiment. Display devices are mounted on a horizontal bar 1102 installed in a gate 1101, and a display device lights up to correspond to a frontage at which an item as a picking object is stored. When a shelf having a different shelf position has arrived at the gate 1101, the bar 1102 automatically moves up or down in accordance with the position of the shelf plate. The position of the shelf plate is accumulated in the data accumulating unit 300 in advance. When a conveyor having a corresponding shelf approaches the picking station, the picking station is notified of information on the position of the shelf plate. The picking station moves the bar 1102 up or down based on the received information on the position of the shelf plate.

When the shelf and the conveyor move away from the picking station, the bar 1102 moves to a predetermined position (below a sight line position of a worker), and all indicators are made to light up to indicate that entry of the worker is prohibited. Further, the display device may flash or display a message or the like, to indicate prohibition of the entry. In this manner, it is possible to make entry of the worker into a region where the shelf and the conveyor are moving difficult physically.

### Ninth Embodiment

In the ninth embodiment, an example is described in which the height of the gate-type picking display device described in the first embodiment is reduced.

FIG. 13 is a diagram showing a picking display device according to the ninth embodiment. In the first embodiment, the gate-type picking display device larger than a shelf in height is described. In this picking display device, there is a risk that a worker's hand may be caught between the shelf and the gate because of movement of a conveyor while the worker puts its hand into the shelf. Therefore, in the ninth embodiment, the display device is a gate type having the height corresponding to the position of the lowest shelf plate in the shelf. This can enable a position at which an item as an object is stored to be displayed, without the risk that the worker's hand is caught.

The invention made by the present inventor has been specifically described based on the embodiments in the above. However, the present invention is not limited to the aforementioned embodiments, but can be changed in various ways without departing from the sprit thereof.

Each of the components, functions, and processing units and the like can be achieved in form of hardware by being entirely or partially designed by an integrated circuit, for example, or in form of software by execution of a program achieving each function by a processor. The program achieving each function and information such as a table can be stored in a storage device such as a memory or a hard disk, or a storage medium such as an IC card or a DVD.

### LIST OF REFERENCE SIGNS

100: picking display device
101: shelf
102: conveyor
103: gate provided with display devices
104: enlarged view
201: controller
202: conveyor
203: picking station
300: data accumulation unit
301: data reading unit 301
302: data collation unit
303: movement instructing unit
304: position receiving unit
305: movement instruction receiving unit
306: position notifying unit
307: data receiving unit
308: item position collation unit
309: display device control unit
310: position detection unit
401: data example
500: illustration of conveyor movement
700: data receiving unit
701: data reading unit
702: data collation unit
703: movement instructing unit
705: movement instruction receiving unit
707: data receiving unit
708: item position collation unit
709: display device control unit
710: POSITION DETECTION UNIT
1101: display device gate
1102: display bar
1103: display bar

1. A picking display device comprising:
a conveyor configured to convey a picking object;
a controller configured to give an instruction to the conveyor;
a picking station configured to perform a picking instruction;
a conveyor position notifying unit by which the conveyor notifies the controller of a position of the conveyor on a map;
a conveyor position receiving unit configured to receive the position notified by the conveyor position notifying unit;
a conveyor movement instruction unit by which the controller gives a movement instruction to the conveyor;
a movement instruction receiving unit configured to receive the instruction from the controller;
a data collation unit configured to specify a conveyor which is to arrive at the picking station from the position of the conveyor on the map, and check information on a corresponding item stored in a shelf held by the conveyor;
an item position collation unit configured to receive a frontage position of the checked corresponding item in the shelf, and check the frontage position of the item;
a position detection unit configured to detect a moved position of the conveyor on the map;
an item position collation unit configured to give a shelf frontage position of an item as the picking object stored in the shelf held by the conveyor; and
a display device unit configured to analyze the position of the conveyor on the map and the shelf storage frontage position of the item as the picking object, and change a display position of a display device indicating a predetermined item position in conjunction with movement of the conveyor.

2. The picking display device according to claim 1, wherein the display device unit includes a device that surrounds a storage place of the object stored in the shelf conveyed by the conveyor and displays a corresponding position by lighting up in response to the instruction.

3. The picking display device according to claim 1, wherein, when the conveyor has arrived at a predetermined location on the map, the position notifying unit notifies the controller of arrival and a current position of the conveyor, and the controller specifies the conveyor that is to arrive and the storage item location in the data collation unit, and instructs the frontage position of the item stored in the shelf held by the conveyor before the conveyor arrives at the picking station.

4. The picking display device according to claim 1, wherein the display device unit projects the frontage position of the item stored in the shelf onto the shelf conveyed by the conveyor, and moves the projected display position in conjunction with the movement of the conveyor.

5. The picking display device according to claim 4, wherein the display device unit projects a horizontal line and a vertical line that extend through the frontage position of the shelf in which the object item is stored so that the position of the object item is instructed by an intersection.

6. The picking display device according to claim 1, wherein the display device unit displays information of the object item to be picked and the number of items to be picked near the position of the item stored in the shelf.

7. The picking display device according to claim 1,
wherein the display device unit includes a gate provided with the display devices and a panel, and
the panel clearly separates a workable area of the conveyor and a workable area of a worker.

8. The picking display device according to claim 1,
wherein the display device unit includes a shutter provided with display devices and a panel,
the shelf frontage position in which the item is stored is displayed before arrival of the conveyor, and
the shutter at a shelf frontage in which a corresponding item is stored is opened and closed when the conveyor has arrived and stopped.

9. The picking display device according to claim 1,
wherein the display device unit has a function of connecting to a conveyor,
the conveyor and the display device unit are connected to each other during picking, and
the connection is released in response to a picking termination instruction.

10. The picking display device according to claim 1,
wherein the picking station:
holds information on the shelf conveyed by the conveyor, the storage position and a name of an item to be picked, and the like,
detects the conveyor when the conveyor approaches the picking station,
reads out the information on the storage position of the item in association with the detection, and
makes a corresponding indicator of the display device light up.

11. A picking display system comprising at least:
a conveyor configured to convey a shelf;
a controller configured to give a conveying instruction to the conveyor based on pre-stored map information; and
a display device arranged near a conveying target position of the conveyor,
wherein the controller includes a data collation unit configured to specify the conveyor that is expected to arrive at the conveying target position, and check information on an item as a picking object stored in the shelf conveyed by the conveyor before the conveyor arrives at the conveying target positron, and
an item position collation unit configured to specify a frontage position in the shelf in which the checked item as the picking object is loaded, and
the controller gives a control instruction to the display device such that the display device displays the frontage position in the shelf in which the item as the picking object is loaded in conjunction with movement of the conveyor toward the conveying target position, when the conveyor has arrived at a position where the display device is arranged.

12. The picking display system according to claim 11, wherein the conveyor includes a conveyor position notifying unit for notifying the controller a position of the conveyor, and the controller includes a conveyor position receiving unit that receives the position from the conveyor position notifying unit.

13. The picking display system according to claim 11,
wherein the display device is arranged at a position away from a conveyance path of the conveyor and has a gate shape along an outer periphery of the shelf, and
the display device performs display in conjunction with the movement of the conveyor toward the conveying target position in response to the control instruction from the controller.

14. The picking display system according to claim 11,
wherein the display device:
has a mechanism of moving a bar up and down,
moves the bar up and down to correspond to a shelf plate position of the shelf received by the controller, and
displays a frontage position in which the item as the object is stored.

15. The picking display system according to claim 11, wherein the conveying target position is a picking station in which picking is performed.
